(19) United States
(12) Patent Application Publication
(10) Pub. No.: US 2018/0060964 A1
(43) Pub. Date: Mar. 1, 2018

(54) INTELLIGENT AGENT AS COMPETITOR AND COLLABORATOR IN A SYSTEM FOR ADDRESSING AN ENTERPRISE OPPORTUNITY

(71) Applicant: International Business Machines Corporation, Armonk, NY (US)

(72) Inventors: Pritpal S. Arora, Bangalore (IN); Bijo S. Kappen, Bangalore (IN); Gopal S. Pingali, Mohegan Lake, NY (US); Adinarayana Sakala, Tirupati (IN)

(21) Appl. No.: 15/254,489

(22) Filed: Sep. 1, 2016

(51) Int. Cl. G06Q 40/06

(52) U.S. Cl. CPC G06Q 40/06

(57) ABSTRACT

A method for addressing an enterprise opportunity which includes: providing an autonomous intelligent agent that is enabled to carry out tasks; and identifying the enterprise opportunity to the intelligent agent. Responsive to the enterprise opportunity being identified to the intelligent agent, the intelligent agent: evaluating a monetary value of the enterprise opportunity to the enterprise and a time frame to present a solution to the enterprise opportunity; determining compute, storage and network resources to invest in the enterprise opportunity based on the value and timeframe of the enterprise opportunity; provisioning the compute, storage and network resources in one or more computer systems; searching an opportunities database for previous opportunities and solutions to the previous opportunities to find a previous opportunity and a previous solution to match the enterprise opportunity; when the previous opportunity matches the enterprise opportunity, providing the solution to the previous opportunity for the enterprise opportunity.

### BACKGROUND

The present exemplary embodiments pertain to opportunities presented to a business enterprise and, more particularly, a method and system to rapidly create solutions for the opportunities and to create value for the business enterprise.

Business enterprises often taken too long to solve a problem or create new value. That is, it takes too long to create awareness of a problem or an opportunity among the people who could do something about it in the business enterprise, to motivate these people to address the problem or opportunity, to effectively bring together the different ideas and approaches from different people into an effective solution for the problem or opportunity at hand, to validate the solution, and to get the validated solution to relevant stakeholders.

The above delays experienced by business enterprises result in loss of time and money for the business enterprise, loss of competitiveness, lost opportunities, and sub-optimal leverage of expertise within the business enterprise.

### BRIEF SUMMARY

The various advantages and purposes of the exemplary embodiments as described above and hereafter are achieved by providing, according to an aspect of the exemplary embodiments, a computer-implemented method for addressing an enterprise opportunity comprising: providing an autonomous intelligent agent that is enabled to carry out tasks; and identifying the enterprise opportunity to the intelligent agent. Responsive to the enterprise opportunity being identified to the intelligent agent, the intelligent agent: evaluating a monetary value of the enterprise opportunity to the enterprise and a time frame to present a solution to the enterprise opportunity; determining compute, storage and network resources to invest in the enterprise opportunity based on the value and timeframe of the enterprise opportunity; provisioning the compute, storage and network resources in one or more computer systems; searching an opportunities database for previous opportunities and solutions to the previous opportunities to find a previous opportunity and a previous solution to match the enterprise opportunity; when the previous opportunity matches the enterprise opportunity, providing the solution to the previous opportunity for the enterprise opportunity.

According to another aspect of the exemplary embodiments, there is provided a computer program product for addressing an enterprise opportunity comprising a computer readable storage medium having program instructions embodied therewith, the program instructions executable by a processor to cause the processor to perform a method comprising: providing an autonomous intelligent agent that is enabled to carry out tasks; and identifying the enterprise opportunity to the intelligent agent. Responsive to the enterprise opportunity being identified to the intelligent agent, the intelligent agent: evaluating a monetary value of the enterprise opportunity to the enterprise and a time frame to present a solution to the enterprise opportunity; determining compute, storage and network resources to invest in the enterprise opportunity based on the value and timeframe of the enterprise opportunity; provisioning the compute, storage and network resources in one or more computer systems; searching an opportunities database for previous opportunities and solutions to the previous opportunities to find a previous opportunity and a previous solution to match the enterprise opportunity; when the previous opportunity matches the enterprise opportunity, providing the solution to the previous opportunity for the enterprise opportunity.

According to a further aspect of the exemplary embodiments, there is provided a system for addressing an enterprise opportunity comprising: at least one non-transitory storage medium that stores instructions; and at least one processor that executes instructions to: provide an autonomous intelligent agent that is enabled to carry out tasks; identify the enterprise opportunity to the intelligent agent; responsive to the enterprise opportunity being identified to the intelligent agent, the intelligent agent: evaluating a monetary value of the enterprise opportunity to the enterprise and a time frame to present a solution to the enterprise opportunity; determining compute, storage and network resources to invest in the enterprise opportunity based on the value and timeframe of the enterprise opportunity; provisioning the compute, storage and network resources in one or more computer systems; searching an opportunities database for previous opportunities and solutions to the previous opportunities to find a previous opportunity and a previous solution to match the enterprise opportunity; when the previous opportunity matches the enterprise opportunity, providing the solution to the previous opportunity for the enterprise opportunity.

### BRIEF DESCRIPTION OF SEVERAL VIEWS OF THE DRAWINGS

The features of the exemplary embodiments believed to be novel and the elements characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 depicts a cloud computing environment according to an embodiment of the present invention.

FIG. 2 depicts abstraction model layers according to an embodiment of the present invention.

FIG. 3A, FIG. 3B and FIG. 3C together illustrate a flow chart illustrating the Enterprise Rapid Value Generator System of the exemplary embodiments.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

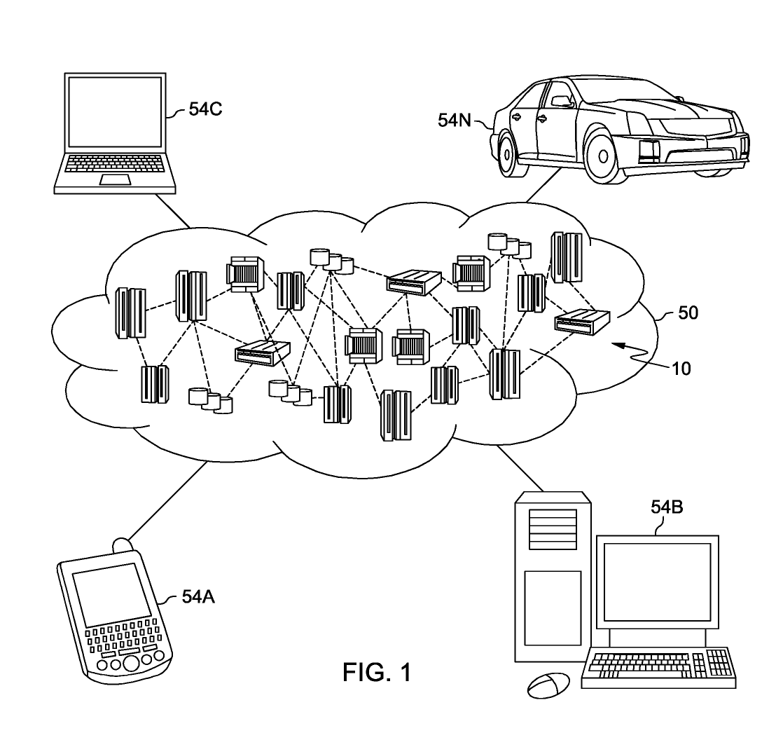

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

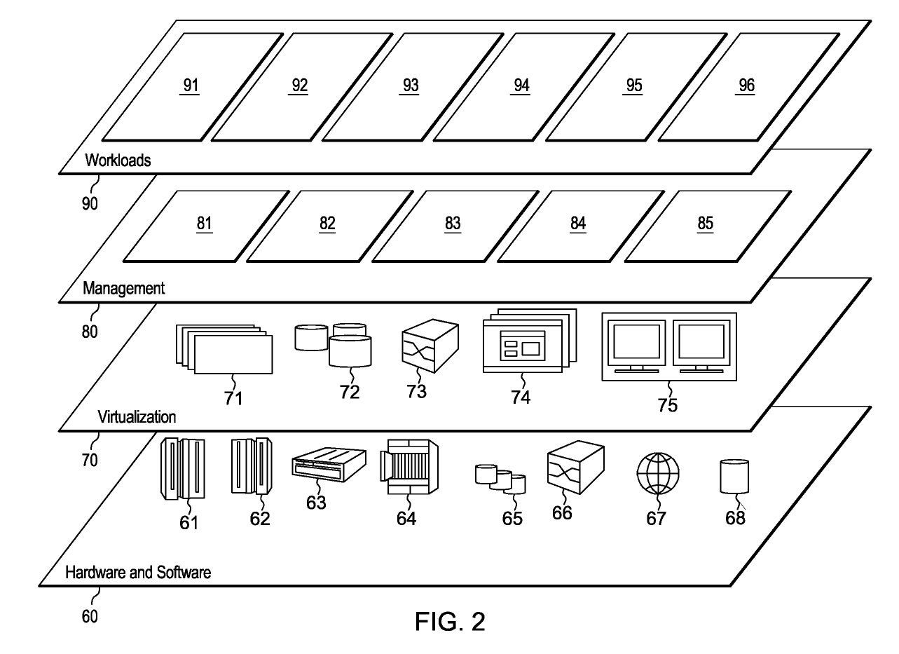

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Enterprise Rapid Value Generator System 96.

There are presently a number of collaborative systems in the business enterprise such as ideation blogs, collaborative tools and virtual gaming systems. However, these collaborative systems are deficient in addressing opportunities for the business enterprise due to:
A lack of focus on value creation across the enterprise.
Not propagating crucial opportunities for value creation rapidly enough through the business enterprise.
Not driving people to participate in the opportunity.
Depending on people volunteering/agreeing to contribute to addressing the opportunity with a resulting insufficient focus on converging to value at high speed.
Failing to link disparate solutions to an opportunity and suggesting these automatically to contributors.
Failing to automatically compose new solutions to address the opportunity based on both current contributions and similar solutions in the past.

The exemplary embodiments pertain to a method and system for an intelligent virtual agent in a socio-technical system for rapid value creation in a business enterprise. The intelligent agents acts as both a collaborator and a competitor to human contributors to a value creation opportunity by linking disparate and historical solution contributions. The intelligent agent may also submit potential solutions to opportunity owners and compete for rewards, and also collaborate with human contributors by suggesting complementing solutions to speed up the creation of a viable solution to the opportunity. The end result is to increase speed and competitiveness of potential solutions to the opportunity.

The opportunity may be, for purposes of illustration and not limitation, any activity directed to sales, problem resolution, innovation, research and/or service that a business enterprise may experience.

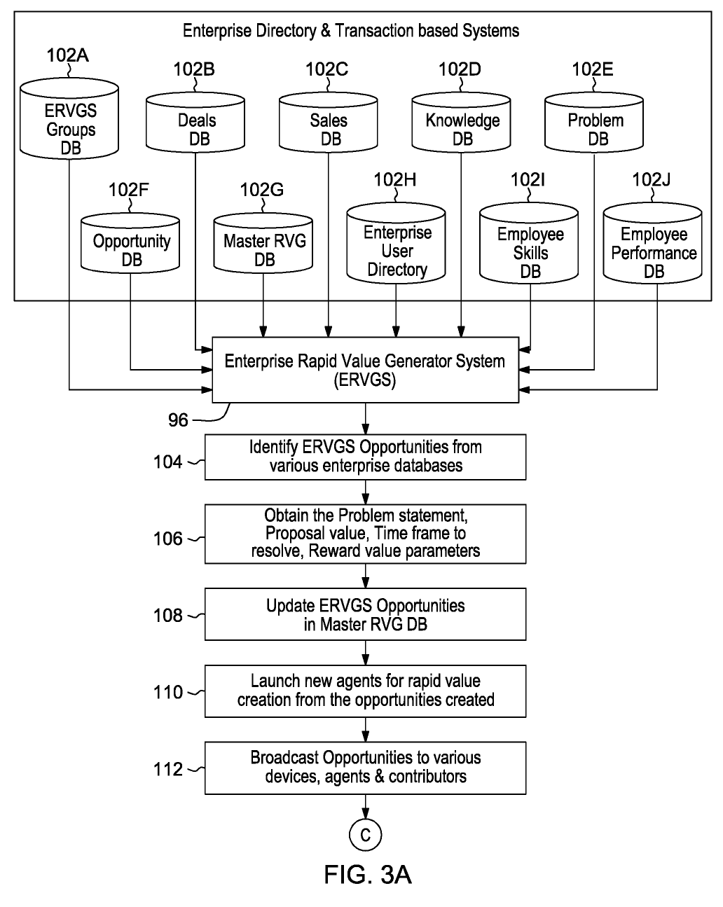

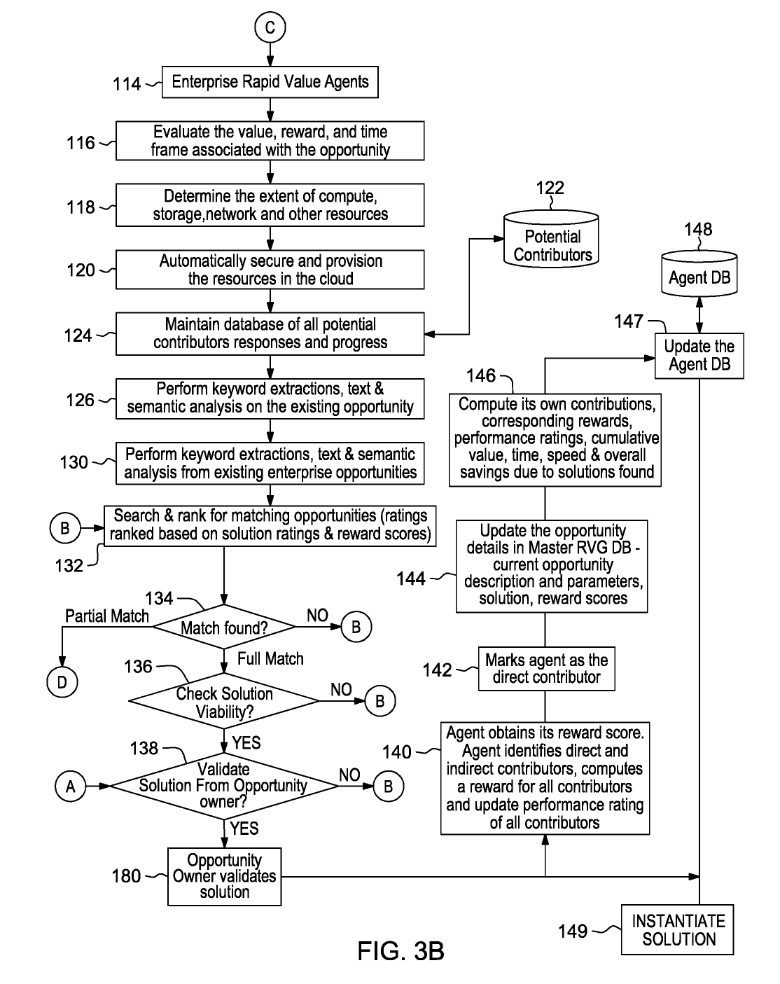

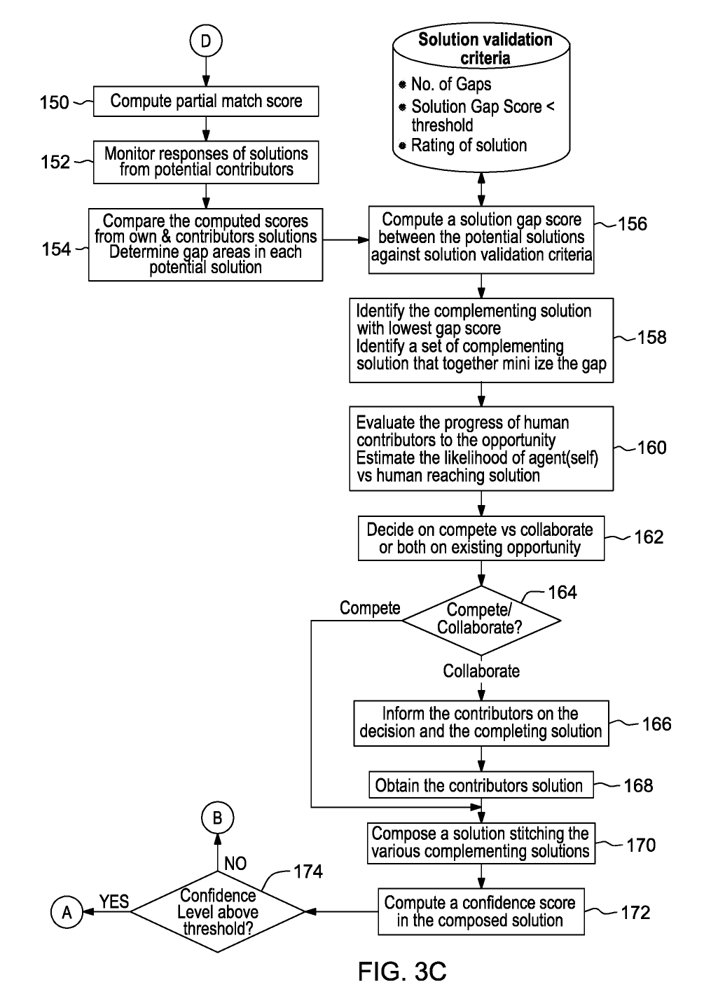

Referring now to FIGS. 3A, 3B and 3C, there is illustrated a flow chart illustrating the method and system of the exemplary embodiments of an Enterprise Rapid Value Generator System (ERVGS) 96. Referring first to FIG. 3A, the ERVGS 96 has access to a plurality of databases 102. These databases may include but not be limited to an ERVGS group database (DB) 102A, a deals database (DB) 102B, a sales DB 102C, a knowledge DB 102D, a problem DB 102E, an opportunity DB 102F, a master RVG DB 102G, an enterprise user directory 102H, an employee skills DB 102I and an employee performance DB 102J. There may be other databases as well and in one exemplary embodiment, all of the databases 102A-J may not be present. The ERVGS 96 and the various databases 102A-J may all reside in the cloud.

The ERVGS Groups DB 102 A contains a master listing of all the opportunities existing within the enterprise with their timelines and reward details.

The Deals DB 102B contains all information pertaining to various deals and engagements within the enterprise

The Sales DB 102C contains all the existing sales information and potential leads.

The Knowledge DB 102D contains all enterprise engagement, delivery and sales repositories.

The Problem DB 102E contains enterprise level issues which are recurring, chronic and persistent in nature and currently being tracked as not resolvable within the enterprise framework with additional details on the requestor, dates of initiating, various solutions depicted and number of attempts to resolve the issue.

The Opportunity DB 102F contains cross referenced details from other databases as such as the Deals DB 102B, Sales DB 102C and contains a reference of all the existing opportunities within the DB.

The Master RVG DB 102G is the master repository of all the existing opportunities available in the enterprise to all employees for resolving and providing value. This contains the definitions of the problem to be solved along with the requestor details and also the value and reward attached to resolve the issue with a specified time frame provided to resolve the issue.

Enterprise User Directory DB 102H contains all user information for the employees within the organization including personal details.

The Employee Skills DB 102I maintains profiles of the employees, their skill matrix, learning details, etc.

The Employee Performance DB 102J contains all performance ratings and appraisal information of the employees.

For the purpose of illustration and not limitation, the above databases are just a sampling of databases within the ERVGS 96. There might be associations, combinations and additional databases that may vary from enterprise to enterprise.

The ERVGS 96 may identify opportunities from various databases, step 104. These databases may be the databases 102A-J shown in FIG. 3A or may be other internal and/or external databases not shown in Figure A.

In step 106, a problem statement of the opportunity, a value of the opportunity and a time frame for the opportunity may be obtained. The problem statement may be a statement of the problem that the opportunity is to address. The value of the opportunity may be simply the monetary value of the opportunity to the business enterprise. The time frame may be the time to resolve the opportunity and provide a solution to the opportunity owner. Reward value parameters of the opportunity may also be obtained. Rewards, including monetary rewards, may be established for the contributors to the solution for the opportunity.

At step 108, the master RVG DB may be updated with the latest ERVGS opportunity.

Then, at steps 110 and 112, intelligent agents may be launched and opportunities broadcast to the intelligent agents.

The flow chart continues on FIG. 3B.

The intelligent agents, grouped under 114, may perform a number of activities. An intelligent agent may be selected to address the opportunity identified in step 104. An intelligent agent, in step 116, evaluates the value and time frame associated with the opportunity. Rewards may be also evaluated for the opportunity.

It should be understood that while one intelligent agent may perform all the functions of the intelligent agent as described hereafter, it is within the scope of the exemplary embodiments for the functions of the intelligent agent to be handled by multiple intelligent agents.

Once the opportunity has been evaluated, resources, including but not limited to, compute, storage and network resources may be determined for the intelligent agent to the extent necessary to perform its activities, step 118, in addressing the opportunity and these resources may be secured and provisioned by the intelligent agent, step 120. That is, the intelligent agent may search for resources that are available or may become available, such as authorizing the purchase of additional resources, and secure those resources for the intelligent agent. In one exemplary embodiment, these resources may be in the cloud.

The resources that the intelligent agent determines and procures are for both finding a solution to the opportunity and then working on the opportunity. This is a decision about how many resources can be invested on an opportunity depending on the value and reward associated with that opportunity. The intelligent agent determines and computes the resource requirements for it to enable to fulfill all its core functions, including but not limited to, finding solutions for the opportunities, maintaining contributors' contributions, performing keyword extractions for comparing solutions, searching and ranking solutions, validating solutions, collaborating with other intelligent agents and stitching together a solution from complementary sub-solutions. The core functions of the intelligent agent will be discussed in more detail hereafter.

The intelligent agent may maintain a database, 122, of potential contributors who have been contacted for the opportunity, and the responses of the contributors and the progress of the contributors in addressing the opportunity, step 124.

The intelligent agent may evaluate the specification of the opportunity, extract keywords, and also perform a semantic analysis of the opportunity, step 126.

The intelligent agent may access the opportunity database 102F of all previous opportunities in the business enterprise and search this enterprise opportunity database 128. Similarly to step 126, the intelligent agent may perform keyword extractions and text and semantic analysis from prior opportunities, step 130.

Based both on keywords and semantics, the intelligent agent may identify matching opportunities from the enterprise opportunity database 128, step 132. The intelligent agent may also use the solution ratings and reward scores associated with the opportunities in the enterprise opportunity database 128 to find the best potential matches.

Matching of a solution to an opportunity is based on matching keywords as well as performing semantic analysis on an existing solution against the description of the opportunity. The matching solutions are also checked for their ratings. These ratings for the matching solutions are based on how useful the matching solutions were to other users. The new opportunities are matched by looking through the existing solutions and their solution ratings.

Referring now to decision step 134, if a complete matching opportunity is found, the “FULL MATCH” path is followed and the intelligent agent performs a first evaluation of the corresponding solution of the matching opportunity to check for solution viability, step 136. For solution viability, the intelligent agent pre-checks the corresponding solution against a list of pre-validated procedures as part of viability assessment. Next, the intelligent agent checks to see if the corresponding solution of the matching opportunity meets the validation criteria associated with the current opportunity and validate the corresponding solution, step 138.

Validation criteria may be formulated based on the gaps of the corresponding solution of the matching opportunity against requirements specified in the opportunity. The solution may be scored in terms of major gaps/minor gaps, and whether it meets the threshold criteria in terms of fulfillment of the query raised, ratings if already provided for the solutions, deriving basis mapping to previous similar solution searches, etc.

For example, assume the identified opportunity is to “Provide an automated solution to build and configure an enterprise content management middleware on a public cloud environment within ten minutes at less than $10000.” The validation criteria associated with this solution could be 1) build and configure enterprise content management middleware; 2) works on public cloud; 3) is done in less than 10 minutes; 4) is automated; 5) cost is less than $10000; 6) extent of manual configuration needed after build. When the intelligent agent searches for solutions, the intelligent agent analyses the solution and matches and scores the solution against each of these validation criteria.

If validation is successful, the intelligent agent then sends the corresponding solution of the matching opportunity to the opportunity owner for final validation, step 180.

If the corresponding solution of the matching opportunity is successfully validated, the process proceeds to step 140. In this step, the intelligent agent obtains its reward score for the matching opportunity. The intelligent agent also looks up both the direct and indirect contributors to the matching solution it found and computes a reward for all indirect and direct contributors and links to employee performance systems. The intelligent agent may automatically update the enterprise performance rating systems of all the contributors with an incremental score proportional to their contribution as well as a summary of the contribution.

Direct contributors are people who have worked directly on the opportunity. There can be scenarios where direct contributors can refer to other contributors in which case the latter contributors would become the direct contributors and the first direct contributors would become indirect contributors.

The intelligent agent may also be in contention for rewards. The criteria for rewards for intelligent agents and non-intelligent agent contributors is the same depending on the nearness of the solution to the requirements, meeting viability and validation criteria.

The concept of an intelligent agent getting reward points is derived from the fact that it is an equivalent competitor who is able to derive solutions on its own. The intelligent agent is proposed to have its own performance ratings and rewards and bonus points. This will give an indication of how much savings the intelligent agent is able to bring in terms of monetary rewards which would have normally gone to the individual employees and also how much business value the intelligent agent provided.

Further, in step 142, the intelligent agent may indicate that the intelligent agent is the direct contributor. Non-intelligent agents may also be direct contributors. The intelligent agent may then update the Master RVG DB 102G with the current opportunity description and parameters, solution, reward score, and indicate that the intelligent agent is the direct contributor and the contributors to the matching solution as indirect contributors at different levels, step 144.

The intelligent agent also computes and propagates a proportionate reward of its contribution to the opportunity, step 146.

The intelligent agent, in step 147, also updates an intelligent agent DB 148, which keeps track of the intelligent agent's contributions, corresponding rewards, performance ratings, and cumulative value delivered to the enterprise in terms of opportunities addressed, corresponding value for each, speed at which value was created, and savings due to solutions found by the intelligent agent rather than by other contributors.

If a matching opportunity was found, the intelligent agent may then instantiate the solution, step 149. The exemplary embodiments include both identifying a solution and working on the solution itself. The intelligent agent may instantiate the solution in the owner's computing resources and consider implementation based solutions such as generating codes, deployment scenarios, migration methodologies, etc.

It should be understood that after the opportunity owner validates the solution, step 180, the process may proceed directly instantiate the solution, step 149.

The exemplary embodiments may end after the intelligent agent DB 148 is updated, step 147, if the opportunity owner decides to not proceed to instantiation, step 149. Alternatively, the exemplary embodiments may end after instantiation, step 149. In either scenario, the ERVGS 96 may await the next opportunity.

Returning now to step 134 to address the situation where no matching opportunity has been found. If no matching opportunity has been found or if the validation criteria is not met or if validation fails, the “NO” path from steps 134, 136, 138 is followed back to step 132 to search for matching opportunities. If the intelligent agent checks against the pre-validation criteria and meets all the criteria, a “full match” is found. If only certain criteria are met and some gaps in the criteria are pending, the match is termed a “partial match”.

In step 132, the intelligent agent may launch a search across external and internal sources for matching solutions to the current opportunity.

Referring now to FIG. 3C where the flow chart continues, if a partial matching solution to the current opportunity is found, the intelligent agent computes a progress/partial match score of all the potential solutions it has currently found, step 150.

The intelligent agent may also monitor all registered contributors for the current opportunity to see if any participants may have submitted potential solutions, step 152.

The agent intelligent obtains and/or computes the matching scores of each submitted solution as well as the solutions it has found through its own search and also determines gap areas in each potential solution for the current opportunity against the solution validation criteria associated with the opportunity, step 154. The intelligent agent may also compute a solution gap score between the potential solutions against the solution validation criteria, step 156. The solution validation criteria was described previously with respect to step 138.

The intelligent agent may identify a set of complementing solutions that together minimize the gaps with respect to the solution criteria for the current opportunity and then identify the complementing solution with the lowest gap score, step 158. Each solution is matched against the solution validation criteria. If two solutions partially match a complementary subset of the solution validation criteria, they are considered to be complementing solutions. The intelligent agent would find similar and complementing solutions from the various databases that the intelligent agent may have access to.

The agent then evaluates the progress of human contributors to the opportunity with its own progress and estimates the likelihood of a human contributor reaching the solution as well as the likelihood of the intelligent agent reaching the solution by itself, step 160. Likelihood for the intelligent agent reaching a solution for the opportunity would be a continuous review cycle to perform a gap analysis by the intelligent agent vis-à-vis the same solution worked by the human performing a review gap analysis. Based on these likelihoods, the intelligent agent decides if it should collaborate and make suggestions to the human contributors, or just compete with the human contributors, or both compete and collaborate, step 162. The decision of the intelligent agent deciding to compete and/or collaborate may involve criteria, at a checkpoint at a desired frequency, such as (1) whether the intelligent agent or human contributors will be able to reach the desired solution sooner and (2) from the current solution snippet, whether the intelligent agent will be able to derive any alternative solution or is proposing the same solution as the human contributors. Based on these criteria, the intelligent agent may decide on compete versus collaborate.

Referring to decision step 164, based on the decision in step 162 to collaborate, the intelligent agent automatically suggests the complementing solutions that it has found to the contributors of potential solutions. Thereafter, the intelligent agent obtains the contributors' solutions, step 168, and composes a combined solution of the intelligent agent complementing solutions and the contributors' solution, step 170. The agent thus becomes a collaborator and an indirect contributor to current contributors to an opportunity.

Referring back to decision step 164, based on the decision step 162, the intelligent agent may choose to compete with the other contributors. The intelligent agent stitches together a solution by the intelligent agent itself using the complementing solutions it has previously identified in step 158. The intelligent agent first determines among the complementing solutions the prime candidate for a main body of the solution, then determines the gaps in this main body with respect to the solution criteria. For each identified gap the intelligent agent identifies the complementing solution or sub-set of the complementing solution that is most relevant. Then the intelligent agent inserts this complementing subset into the main body and makes changes in the resulting solution to ensure language continuity, logical continuity, and minimization of contradictions. The intelligent agent may also highlight the changes made in stitching the various complementing solutions and may provide linkage to the original complementing solutions to enable a human to access these and understand the stitched solution.

While the above discussion has focused on the intelligent agent being a competitor or a collaborator, it should be understood that the intelligent agent may be both a competitor and a collaborator in stitching together a final solution.

In both cases where the intelligent agent is a collaborator or a competitor, the intelligent agent computes a confidence score in the composed solution by analyzing the level of continuity, completeness, contradiction in the solution as well as the reputation of the contributors to the complementing solution, step 172. Confidence level would be a direct function of, and inversely proportional to, the gaps found in the solution during the pre-validation phase or validation by the originator.

Referring now to decision step 174, if the confidence level computed in step 172 is above a predetermined threshold, the intelligent agent submits this composed solution back to step 138 for validation and if the composed solution successfully passes the solution validation criteria, the composed solution is passed to the opportunity owner for validation, step 180, and then for instantiation, step 149, in the owner's computing resources as described above. If the confidence level computed in step 172 is below the predetermined threshold, the process proceeds back to step 132 to search for another matching opportunity. The threshold is a compare algorithm in which the threshold can a) be a preprogrammed default value or b) a configurable parameter set for a particular scenario or organization etc. The system also can update the default based on the typical manually configured parameters (i.e. the thresholds are learnt/fine-tuned over time).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent to those skilled in the art having regard to this disclosure that other modifications of the exemplary embodiments beyond those embodiments specifically described here may be made without departing from the spirit of the invention. Accordingly, such modifications are considered within the scope of the invention as limited solely by the appended claims.

What is claimed is:

1. A computer-implemented method for addressing an enterprise opportunity comprising:
providing an autonomous intelligent agent that is enabled to carry out tasks;
identifying the enterprise opportunity to the intelligent agent;
responsive to the enterprise opportunity being identified to the intelligent agent, the intelligent agent:
evaluating a monetary value of the enterprise opportunity to the enterprise and a time frame to present a solution to the enterprise opportunity;
determining compute, storage and network resources to invest in the enterprise opportunity based on the value and timeframe of the enterprise opportunity;
provisioning the compute, storage and network resources in one or more computer systems;
searching an opportunities database for previous opportunities and solutions to the previous opportunities to find a previous opportunity and a previous solution to match the enterprise opportunity;
when the previous opportunity matches the enterprise opportunity, providing the solution to the previous opportunity for the enterprise opportunity.

2. The method of claim 1 further comprising instantiating the solution to the previous opportunity in computing resources.

3. The method of claim 1 wherein when the previous opportunity does not match the enterprise opportunity in its entirety, further comprising the intelligent agent:
searching the opportunities database to find opportunities having partial solutions to the enterprise opportunity;
identifying gaps between the partial solutions and the enterprise opportunity;
identifying complementing solutions to the enterprise opportunity such that the complementing solutions minimize the gaps;
deciding whether to compete with the partial solutions by offering the complementing solutions to an opportunity owner, collaborating with the partial solutions by combining the partial solutions with the complementing solutions or both; and
providing a resulting solution to the enterprise opportunity.

4. The method of claim 3 further comprising instantiating the resulting solution in computing resources.

5. The method of claim 1 wherein the compute storage and network resources are provisioned for the intelligent agent.

6. The method of claim 1 wherein the compute storage and network resources are provisioned for the solution to the enterprise opportunity.

7. The method of claim 1 further comprising evaluating the previous opportunity for conformance to a validation criteria.

8. The method of claim 1 wherein the previous opportunities have a rating and the solution for the enterprise opportunity has a rating and further comprising comparing the previous opportunities ratings to the enterprise rating to determine if there is a complete or a partial match.

9. The method of claim 1 wherein the compute storage and network resources are provisioned in the cloud.

10. A computer program product for addressing an enterprise opportunity comprising a computer readable storage medium having program instructions embodied therewith, the program instructions executable by a processor to cause the processor to perform a method comprising:
providing an autonomous intelligent agent that is enabled to carry out tasks;
identifying the enterprise opportunity to the intelligent agent;
responsive to the enterprise opportunity being identified to the intelligent agent, the intelligent agent:
evaluating a monetary value of the enterprise opportunity to the enterprise and a time frame to present a solution to the enterprise opportunity;
determining compute, storage and network resources to invest in the enterprise opportunity based on the value and timeframe of the enterprise opportunity;
provisioning the compute, storage and network resources in one or more computer systems;
searching an opportunities database for previous opportunities and solutions to the previous opportunities to find a previous opportunity and a previous solution to match the enterprise opportunity;
when the previous opportunity matches the enterprise opportunity, providing the solution to the previous opportunity for the enterprise opportunity.

11. The computer program product of claim 10 further comprising instantiating the solution to the previous opportunity in computing resources.

12. The computer program product of claim 10 wherein when the previous opportunity does not match the enterprise opportunity in its entirety, further comprising the intelligent agent:
searching the opportunities database to find opportunities having partial solutions to the enterprise opportunity;
identifying gaps between the partial solutions and the enterprise opportunity;
identifying complementing solutions to the enterprise opportunity such that the complementing solutions minimize the gaps;
deciding whether to compete with the partial solutions by offering the complementing solutions to an opportunity owner, collaborating with the partial solutions by combining the partial solutions with the complementing solutions or both; and
providing a resulting solution to the enterprise opportunity.

13. The computer program product of claim 12 further comprising instantiating the resulting solution in computing resources.

14. The computer program product of claim 10 further comprising evaluating the previous opportunity for conformance to a validation criteria.

15. The computer program product of claim 10 wherein the previous opportunities have a rating and the solution for the enterprise opportunity has a rating and further comprising comparing the previous opportunities ratings to the enterprise rating to determine if there is a complete or a partial match.

16. A system for addressing an enterprise opportunity comprising:
at least one non-transitory storage medium that stores instructions; and
at least one processor that executes instructions to:
provide an autonomous intelligent agent that is enabled to carry out tasks;
identify the enterprise opportunity to the intelligent agent;
responsive to the enterprise opportunity being identified to the intelligent agent, the intelligent agent:
evaluating a monetary value of the enterprise opportunity to the enterprise and a time frame to present a solution to the enterprise opportunity;
determining compute, storage and network resources to invest in the enterprise opportunity based on the value and timeframe of the enterprise opportunity;
provisioning the compute, storage and network resources in one or more computer systems;
searching an opportunities database for previous opportunities and solutions to the previous opportunities to find a previous opportunity and a previous solution to match the enterprise opportunity;
when the previous opportunity matches the enterprise opportunity, providing the solution to the previous opportunity for the enterprise opportunity.

17. The system of claim 16 further comprising instructions to instantiate the solution to the previous opportunity in computing resources.

18. The system of claim 16 wherein when the previous opportunity does not match the enterprise opportunity in its entirety, further comprising the intelligent agent:
searching the opportunities database to find opportunities having partial solutions to the enterprise opportunity;
identifying gaps between the partial solutions and the enterprise opportunity;
identifying complementing solutions to the enterprise opportunity such that the complementing solutions minimize the gaps;
deciding whether to compete with the partial solutions by offering the complementing solutions to an opportunity owner, collaborating with the partial solutions by combining the partial solutions with the complementing solutions or both; and
providing a resulting solution to the enterprise opportunity.

19. The system of claim 18 further comprising instructions to instantiate the resulting solution in computing resources.

20. The system of claim 16 wherein the compute storage and network resources are provisioned in the cloud for the intelligent agent and for the solution to the enterprise opportunity.
